(19) United States
(12) Patent Application Publication
(10) Pub. No.: US 2022/0279965 A1
(43) Pub. Date: Sep. 8, 2022

(54) GRIDDLE WITH SMOKE VENTS

(71) Applicant: UNITED STATES STOVE COMPANY, South Pittsburg, TN (US)

(72) Inventor: Brandon Lane Barry, Sewanee, TN (US)

(21) Appl. No.: 17/689,113

(22) Filed: Mar. 8, 2022

Related U.S. Application Data
(60) Provisional application No. 63/158,257, filed on Mar. 8, 2021.

(51) Int. Cl. A47J 37/07

(52) U.S. Cl. CPC A47J 37/0704; A47J 37/0786

(57) ABSTRACT

A griddle is configured to drop in place of (or on top of) a normal cooking grate of a pellet grill while maximizing heat capture and maintaining proper exhaust flow. In this way, aspects of the invention ensure stable operating temperatures and/or even cooking of food while imparting smoke flavors from burning wood pellets into the food. The griddle includes a cooking surface upon which to cook the food and a smoke trap to allow airflow through the griddle while directing smoke and exhaust gases either toward the food or away from the food, depending upon the orientation of the griddle in the housing relative to an exhaust path of the housing.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

This application claims priority to and hereby incorporates by reference in its entirety U.S. Provisional Patent Application Ser. No. 63/158,257 entitled “GRIDDLE WITH SMOKE VENTS” filed on Mar. 8, 2021.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present invention relates generally to outdoor cooking equipment. More particularly, this invention pertains to wood-fired pellet grills.

In recent years, wood fired pellet grills have been developed as a cooking platform. These grills include a motor, a blower, control logic, and a combustion housing. The combustion housing is configured to hold burning pellets of compressed wood. The motor and blower are operated by the control logic to provide a flow of fresh combustion air to the combustion housing to burn the wood pellets at a specific rate to maintain a desired cooking temperature. Thus, based on the flow rate of the fresh combustion air, a wood fired pellet grill can smoke food at a relatively low temperature and be adjusted to sear food at a relatively high temperature within a relatively short time period. Wood fired pellet grills also often include a grate to support cookware above the burning wood pellets.

### BRIEF SUMMARY OF THE INVENTION

Aspects of the invention provide a griddle designed to drop in place of (or on top of) a normal cooking grate of a pellet grill that maintains proper exhaust flow. In this way, aspects of the invention ensure stable operating temperatures and/or even cooking of food while imparting smoke flavors from burning wood pellets into the food. The griddle includes a cooking surface upon which to cook the food and a smoke trap to allow airflow through the griddle while directing smoke and exhaust gases either toward the food or away from the food, depending upon the orientation of the griddle in the housing relative to an exhaust path of the housing.

In one aspect, the griddle includes a cooking surface and a smoke trap. The cooking surface is configured to receive heat from heat source under the cooking surface and cook food supported by the cooking surface. The smoke trap extends upwardly from the cooking surface when the griddle is in an upright position. The smoke trap is configured to collect smoke from the heat source under the cooking surface and vent the collected smoke to above the cooking surface.

In another aspect, a pellet grill includes a housing, a hopper, a burn pot, a pellet transfer system, and a griddle. The hopper is configured to store solid fuel pellets therein. The burn pot is inside the housing and configured to burn solid fuel pellets from the hopper therein. The pellet transfer system is configured to move the pellets from the hopper to the burn pot. The griddle includes a cooking surface and a smoke trap. The cooking surface is configured to receive heat from a heat source, wherein the heat source is the burn pot which is under the griddle when the griddle is installed in the housing in an upright position. The cooking surface is further configured to support food and cook the food supported by the cooking surface. The smoke trap extends upwardly from the cooking surface when the griddle is in the upright position. The smoke trap is configured to collect smoke from the burn pot under the cooking surface and vent the collected smoke to above the cooking surface.

### BRIEF DESCRIPTION OF THE SEVERAL VIEWS OF THE DRAWINGS

FIG. 1 is an isometric view of a wood fired pellet grill including a griddle according to one embodiment of the invention.

FIG. 2 is an isometric view of the griddle of FIG. 1.

FIG. 3 is a top view of the griddle of FIGS. 1 and 2.

FIG. 4 is a side view of the griddle of FIGS. 1-3.

FIG. 5 is a top view a pattern to form the griddle of FIGS. 1-4 from sheet material.

FIG. 6 is an exploded isometric view of the pellet grill of FIG. 1.

FIG. 7 is a front cutaway view of a pellet grill including a side exhaust or smoke stack.

Reference will now be made in detail to optional embodiments of the invention, examples of which are illustrated in accompanying drawings. Whenever possible, the same reference numbers are used in the drawing and in the description referring to the same or like parts.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of the embodiments described herein, a number of terms are defined below. The terms defined herein have meanings as commonly understood by a person of ordinary skill in the areas relevant to the present invention. Terms such as “a,” “an,” and “the” are not intended to refer to only a singular entity, but rather include the general class of which a specific example may be used for illustration. The terminology herein is used to describe specific embodiments of the invention, but their usage does not delimit the invention, except as set forth in the claims.

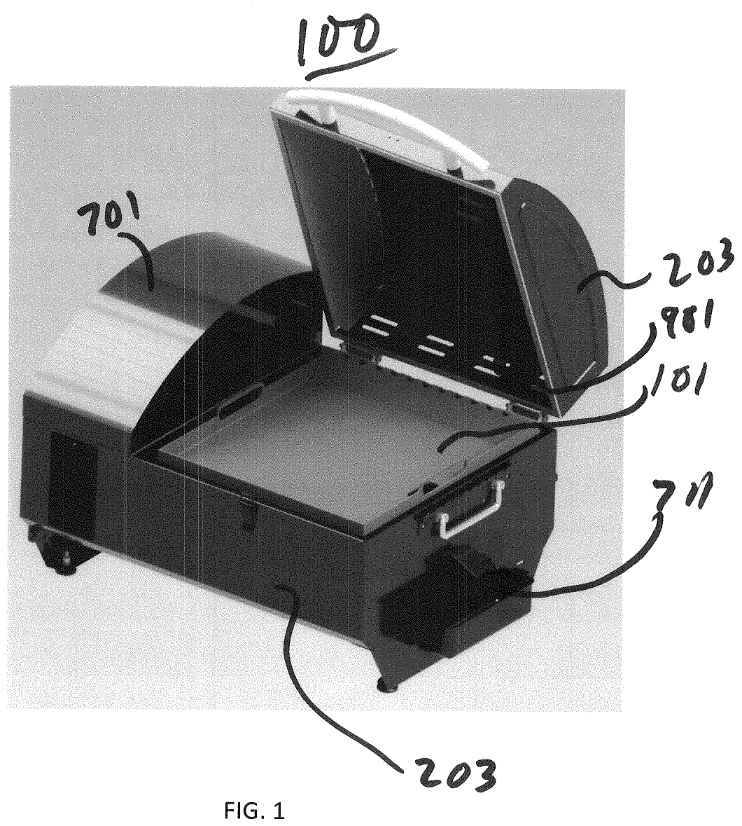

As described herein, an upright position is considered to be the position of apparatus components while in proper operation or in a natural resting position as described herein. The upright position of the griddle is in place of a cooking grate of a pellet grill, wherein the pellet grill is resting on a generally level surface as shown in, for example, FIG. 1. As used herein, pellet grill includes wood pellet smokers (i.e., pellet grills with better sealed cooking chambers and chimneys or smoke stacks designed to retain more smoke than grills with wider opening, more vented cooking chambers). Vertical, horizontal, above, below, side, top, bottom and other orientation terms are described with respect to this upright position during operation unless otherwise specified. The term “when” is used to specify orientation for relative positions of components, not as a temporal limitation of the claims or apparatus described and claimed herein unless otherwise specified. The terms “above”, “below”, “over”, and “under” mean “having an elevation or vertical height greater or lesser than” and are not intended to imply that one object or component is directly over or under another object or component. As used herein, the upright orientation of the griddle is sitting on a level surface with the bottom down and top up such that the griddle is ready for operation or may be in operation.

The phrase “in one embodiment,” as used herein does not necessarily refer to the same embodiment, although it may. Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without operator input or prompting, whether these features, elements and/or states are included or are to be performed in any particular embodiment.

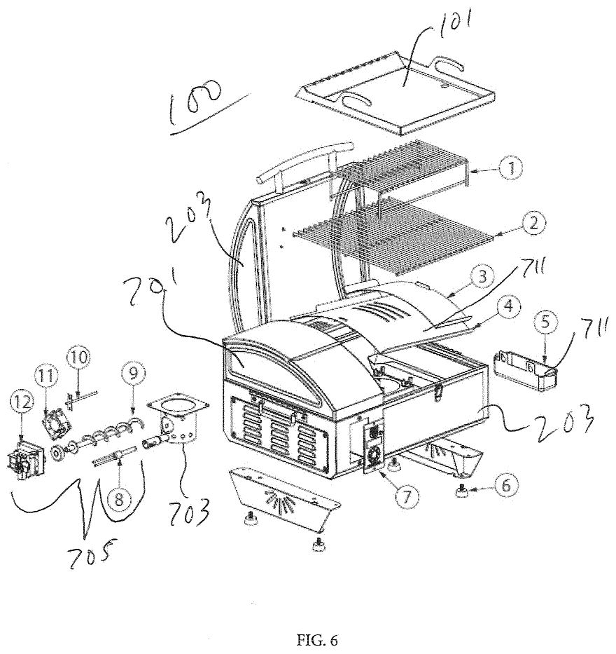

Referring to FIGS. 1-7, a griddle 101 has a smoke trap 103, a cooking surface 105, a first wall 107, a second wall 111, and a third wall 109. The cooking surface 105 is connected to the smoke trap 103, the first wall 107, the second wall 111, and the third wall 109. The smoke trap 103 is connected to the first wall 107 and the third wall 109. The second wall 111 is connected to the first wall 107 and the third wall 109. The first wall 107 is opposite the third wall 109. The second wall 111 is opposite the smoke trap 103. In operation, the cooking surface 105 upwardly supports food being cooked. The first, second, and third walls 107, 111, 109 stiffen the cooking surface 105 and contain food being cooked. In some examples, the griddle 101 is formed of a food grade metal (e.g., cast iron, aluminum, copper, stainless steel, high carbon steel, etc.). The griddle 101 is configured to removably engage with a combustion housing 203 of a wood fired pellet grill 100. In other words, the griddle 101 is configured to be swapped in place of a wood fired pellet grill cooking grate (or placed on top of the cooking grate).

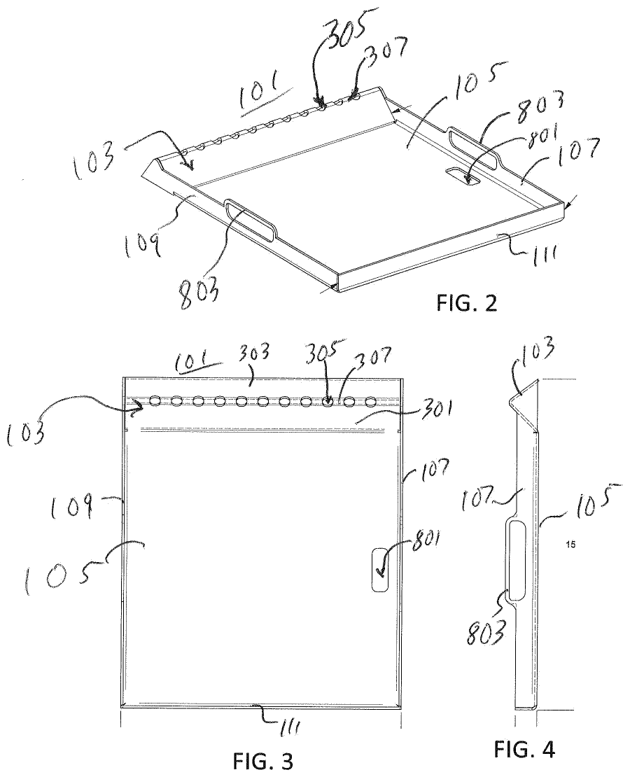

The smoke trap 103 is disposed at one end of the griddle. In one embodiment, the smoke trap 103 is at the rear end of the griddle (i.e., toward a back or hinge of the pellet grill housing 203). Referring especially to FIGS. 1 and 2, the smoke trap 103 is raised relative to the cooking surface 105. In one embodiment, the smoke trap 103 extends higher than the first, second, and third walls 107, 111, 109 when in the griddle 101 is in the upright position. The smoke trap 103 includes a first sloped portion 301 and a second sloped portion 303 connected to one another via a ridge 307. The smoke trap 103 defines at least one venting hole 305. Thus, in some embodiments, the smoke trap 103 defines a plurality of venting holes 305. In some embodiments, the at least one venting hole 305 is an elongated slot. In some embodiments, the at least one venting hole 305 is located along the ridge 307. In another embodiment, the venting hole 305 is located on a rear slope 303 of the griddle 101, and in another embodiment, the venting hole 305 is located on a front slope 301 of the griddle 101. In operation, the smoke trap 103 collects smoke under the first and second sloped portions 301, 303 and the ridge 307 and vents the smoke through the at least one venting hole 305.

In one embodiment, a pellet grill 100 includes a housing 203, a hopper 701, a burn pot 703, a pellet transfer system 705, and the griddle 101. The hopper 701 is configured to store solid fuel wood pellets 707 therein. The burn pot 703 is inside the housing 203, and the burn pot 703 is configured to burn the solid fuel pellet 707 from the hopper 701 therein. In one embodiment, the pellet grill 100 further includes a grease drain 711 or grease management system configured to remove oil and grease from the housing 203.

In one embodiment, the griddle 101 includes the cooking surface 105 and the smoke trap 103. The cooking surface 105 is configured to receive heat from the heat source, wherein the heat source is the burn pot 703 which is under the griddle 101 when the griddle 101 is installed in the housing 203 in an upright position. The cooking surface 105 is further configured to support food and cook the food supported by the cooking surface 105.

The smoke trap 103 extends upwardly from the cooking surface 105 when the griddle 101 is in the upright position. The smoke trap 103 is configured to collect smoke from the burn pot 703 under the cooking surface 105 and vent the collected smoke to above the cooking surface 105. In one embodiment, the smoke trap 103 includes a 1^{st} portion 301, the ridge 307, and a 2^{nd} portion 303. The 1^{st} portion extends upwardly from and defines an end of the cooking surface 105 when the griddle 101 is in the upright position. The ridge 307 is connected to the 1^{st} portion 301 of the smoke trap 103. The 2^{nd} portion 303 is connected to the ridge 307 and extends downwardly there from when the griddle 101 is in the upright position. In one embodiment, the ridge 307 spaces the 2^{nd} portion 303 from the 1^{st} portion 301. In one embodiment, the ridge 307 has at least one venting hole 305 therethrough. The venting hole 305 is configured to allow smoke trapped under the smoke trap 103 to rise up through said venting hole 305. In one embodiment, the 1^{st} portion 301 and the 2^{nd} portion 303 are generally flat, and the ridge 307 is formed by the 1^{st} portion 301 meeting the 2^{nd} portion 303 at an angle of between about 60 and 120 degrees. In one embodiment, the ridge 307 is curved and has a radius of curvature of between about 0.5 and 2 inches. In one embodiment, the 1^{st} portion 301 includes at least a portion (e.g., a majority) of a venting hole 305 such that the at least one venting hole 305 is configured to direct smoke toward food supported by (i.e., on) the cooking surface 105 the smoke passes upward through the at least one venting hole 307.

In one embodiment, the griddle 101 further includes a pair of opposing walls or side walls 107, 109 defining and extending upwardly from opposing ends of the cooking surface 105 when the griddle 101 is in the upright position. The pair of opposing walls 107, 109 encloses opposing ends of the smoke trap 103. In one embodiment, the griddle 101 further includes a wall 111 defining and extending upwardly from an end of the cooking surface 105 opposite the smoke trap 103 when the griddle 101 is in the upright position. The wall 111 is connected to the pair of opposing side walls 107, 109 at the opposing ends of the cooking surface 105.

In one embodiment, each wall of the pair of opposing walls 107, 109 includes a handle 803 extending upwardly therefrom for lifting the griddle 101 from the housing 203 of the pellet grill 100 and placing the griddle 101 into the housing 203 of the pellet grill 100. In one embodiment, the cooking surface 105 includes an outflow 801. The outflow 801 is a hole through the cooking surface 105, and the outflow 801 is configured to drop excess oil and grease from food cooking on the cooking surface 105 to the grease drain or grease management system 711 of the pellet grill 100.

In operation, smoke from burning wood pellets 707 flows up from a combustion chamber (e.g., burn pot 703) of the pellet grill 100 and through the at least one venting hole 307. By venting this smoke and air to a top of the cooking chamber, a thermometer and control logic of the wood fired pellet grill 100 can accurately control a combustion rate of the wood pellets 707 to maintain a set temperature. Thus, the control logic maintains a desired operating temperature of the wood fired pellet grill 100 and a surface temperature of the griddle 101.

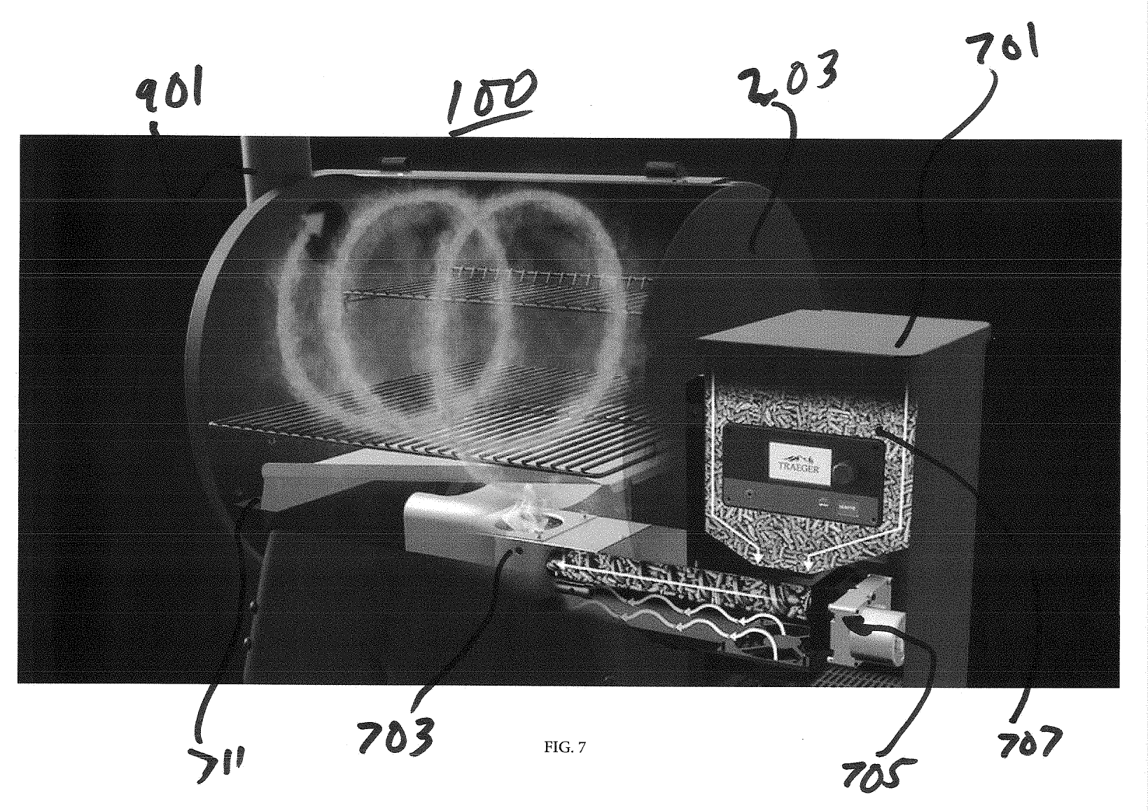

In one embodiment, the griddle 101 is oriented in the grill 100 to form a smoke path from the plurality of venting holes 307 to an exhaust 901 of the grill 100 that traverses food placed on the cooking surface 105. Thus, a relatively heavy smoke flavor is imparted to the food on the cooking surface 105. In some instances, as shown in FIG. 1, the griddle 101 is oriented in the grill 100 to form a more direct smoke path from the plurality of venting holes 307 to the exhaust 901 of the grill 100 that does not traverse food placed on the cooking surface 105. Thus, a relatively reduced smoke flavor is imparted to the food. It should be appreciated by one of ordinary skill in the art that the griddle 101 could be turned 180 degrees to either be near or far from the exhaust vents 901 (or smoke stack 901 as shown in FIG. 7) depending on the amount of smoke flavor a user desires to impart to the food on the cooking surface 105.

In one embodiment, the griddle defines outflow 801 to allow excess cooking liquids to flow into a grease management system or grease drain 711 of the pellet grill 100. In one embodiment, the first wall and the third wall each include handles 803 for a user to place the griddle 101 on the grill 100 and to remove the griddle 101 from the grill 100. Referring to FIG. 1, the griddle 101 is shaped to permit a lid of the grill housing 203 to fully close.

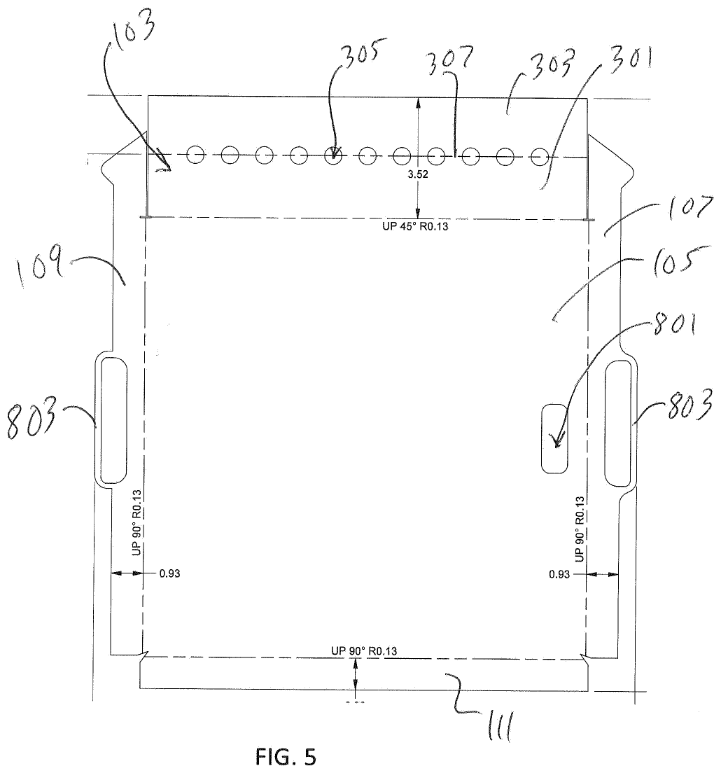

In one embodiment, the griddle 101 is formed of a single piece of metal. That is, the griddle 101 is cut or stamped as shown in FIG. 5, then folded and/or drawn into the shape FIGS. 1-4. The sides or walls 107, 109, 111 and smoke trap 103 may be welded to one another at some or all of where they abut to stiffen the griddle 101 and prevent deformation due to repeated high heat cycling from cooking.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the compositions and/or methods disclosed and claimed herein may be made and/or executed without undue experimentation in light of the present disclosure. While the compositions and methods of this invention have been described in terms of the embodiments included herein, it will be apparent to those of ordinary skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

Thus, although there have been described particular embodiments of the present invention of a new and useful GRIDDLE WITH SMOKE VENTS it is not intended that such references be construed as limitations upon the scope of this invention except as set forth in the following claims

What is claimed is:

1. A griddle comprising:
a cooking surface configured to receive heat from a heat source under the cooking surface and cook food supported by the cooking surface; and
a smoke trap extending upwardly from the cooking surface when the griddle is in an upright position, wherein:
the smoke trap is configured to collect smoke from the heat source under the cooking surface and vent the collected smoke to above the cooking surface.

2. The griddle of claim 1, wherein:
the smoke trap comprises:
a first portion extending upwardly from an end of the cooking surface when the griddle is in the upright position;
a ridge connected to the first portion of the smoke trap; and
a second portion connected to the ridge and extending downwardly therefrom when the griddle is in the upright position.

3. The griddle of claim 1, wherein:
the smoke trap comprises:
a first portion extending upwardly from an end of the cooking surface when the griddle is in the upright position;
a ridge connected to the first portion of the smoke trap; and
a second portion connected to the ridge and extending downwardly therefrom when the griddle is in the upright position, wherein:
the ridge spaces the second portion from the first portion.

4. The griddle of claim 1, wherein:
the smoke trap comprises:
a first portion extending upwardly from an end of the cooking surface when the griddle is in the upright position;
a ridge connected to the first portion of the smoke trap; and
a second portion connected to the ridge and extending downwardly therefrom when the griddle is in the upright position, wherein:
the ridge has at least one venting hole therethrough, said venting hole configured to allow smoke trapped under the smoke trap to rise up through said venting hole.

5. The griddle of claim 1, wherein:
the smoke trap comprises:
a first portion extending upwardly from an end of the cooking surface when the griddle is in the upright position;
a ridge connected to the first portion of the smoke trap; and
a second portion connected to the ridge and extending downwardly therefrom when the griddle is in the upright position, wherein:
the first portion is generally flat;
the second portion is generally flat; and
the ridge is formed by the first portion meeting the second portion at an angle of between about 60 and 120 degrees.

6. The griddle of claim 1, wherein:
the smoke trap comprises:
a first portion extending upwardly from an end of the cooking surface when the griddle is in the upright position;
a ridge connected to the first portion of the smoke trap; and
a second portion connected to the ridge and extending downwardly therefrom when the griddle is in the upright position, wherein:
the ridge is curved and has a radius of curvature of between about 0.5 inches and 2 inches.

7. The griddle of claim 1, wherein:
the smoke trap comprises:
a first portion extending upwardly from an end of the cooking surface when the griddle is in the upright position;
a ridge connected to the first portion of the smoke trap; and
a second portion connected to the ridge and extending downwardly therefrom when the griddle is in the upright position, wherein:
the first portion comprises at least one venting hole such that the at least one venting hole is configured to direct smoke toward food supported by the cooking surface as smoke passes upward through the at least one venting hole.

8. The griddle of claim 1, wherein the griddle further comprises:
a pair of opposing walls defining and extending upwardly from opposing ends of the cooking surface when the griddle is in the upright position, wherein said pair of opposing walls encloses opposing ends of the smoke trap.

9. The griddle of claim 1, wherein the griddle further comprises:
a pair of opposing walls defining and extending upwardly from opposing ends of the cooking surface when the griddle is in the upright position, wherein said pair of opposing walls encloses opposing ends of the smoke trap; and
a wall extending defining and extending upwardly from an end of the cooking surface opposite the smoke trap when the griddle is in the upright position, wherein said wall is connected to the pair of opposing walls at the opposing ends of the cooking surface.

10. The griddle of claim 1, wherein the griddle further comprises:
a pair of opposing walls defining and extending upwardly from opposing ends of the cooking surface when the griddle is in the upright position, wherein each wall of the pair of opposing walls comprises a handle for lifting the griddle from a pellet grill in which the griddle is installed; and
the cooking surface comprises an outflow, wherein said outflow is a hole through the cooking surface and the outflow is configured to drop excess oil or grease from food cooking on the cooking surface to a grease drain of the pellet grill in which the griddle is installed.

11. A pellet grill comprising:
a housing;
a hopper configured to store solid fuel pellets therein;
a burn pot inside the housing configured to burn solid fuel pellets from the hopper therein;
a pellet transfer system configured to move the fuel pellets from the hopper to the burn pot; and
a griddle comprising:
a cooking surface configured to receive heat from a heat source, wherein the heat source is the burn pot which is under the griddle when the griddle is installed in the housing in an upright position and the cooking surface is further configured to support food and cook the food supported by the cooking surface; and
a smoke trap extending upwardly from the cooking surface when the griddle is in the upright position, wherein:
the smoke trap is configured to collect smoke from the burn pot under the cooking surface and vent the collected smoke to above the cooking surface.

12. The pellet grill of claim 11, wherein:
the smoke trap comprises:
a first portion extending upwardly from an end of the cooking surface when the griddle is in the upright position;
a ridge connected to the first portion of the smoke trap; and
a second portion connected to the ridge and extending downwardly therefrom when the griddle is in the upright position.

13. The pellet grill of claim 11, wherein:
the smoke trap comprises:
a first portion extending upwardly from an end of the cooking surface when the griddle is in the upright position;
a ridge connected to the first portion of the smoke trap; and
a second portion connected to the ridge and extending downwardly therefrom when the griddle is in the upright position, wherein:
the ridge spaces the second portion from the first portion.

14. The pellet grill of claim 11, wherein:
the smoke trap comprises:
a first portion extending upwardly from an end of the cooking surface when the griddle is in the upright position;
a ridge connected to the first portion of the smoke trap; and
a second portion connected to the ridge and extending downwardly therefrom when the griddle is in the upright position, wherein:
the ridge has at least one venting hole therethrough, said venting hole configured to allow smoke trapped under the smoke trap to rise up through said venting hole.

15. The pellet grill of claim 11, wherein:
the smoke trap comprises:
a first portion extending upwardly from an end of the cooking surface when the griddle is in the upright position;
a ridge connected to the first portion of the smoke trap; and
a second portion connected to the ridge and extending downwardly therefrom when the griddle is in the upright position, wherein:
the first portion is generally flat;
the second portion is generally flat; and
the ridge is formed by the first portion meeting the second portion at an angle of between about 60 and 120 degrees.

16. The pellet grill of claim 11, wherein:
the smoke trap comprises:
a first portion extending upwardly from an end of the cooking surface when the griddle is in the upright position;
a ridge connected to the first portion of the smoke trap; and
a second portion connected to the ridge and extending downwardly therefrom when the griddle is in the upright position, wherein:
the ridge is curved and has a radius of curvature of between about 0.5 inches and 2 inches.

17. The pellet grill of claim 11, wherein:
the smoke trap comprises:
a first portion extending upwardly from an end of the cooking surface when the griddle is in the upright position;
a ridge connected to the first portion of the smoke trap; and
a second portion connected to the ridge and extending downwardly therefrom when the griddle is in the upright position, wherein:
the first portion comprises at least one venting hole such that the at least one venting hole is configured to direct smoke toward food supported by the cooking surface as smoke passes upward through the at least one venting hole.

18. The pellet grill of claim 11, wherein the griddle further comprises:
a pair of opposing walls defining and extending upwardly from opposing ends of the cooking surface when the griddle is in the upright position, wherein said pair of opposing walls encloses opposing ends of the smoke trap.

19. The pellet grill of claim 11, wherein the griddle further comprises:
a pair of opposing walls defining and extending upwardly from opposing ends of the cooking surface when the griddle is in the upright position, wherein said pair of opposing walls encloses opposing ends of the smoke trap; and
a wall extending defining and extending upwardly from an end of the cooking surface opposite the smoke trap when the griddle is in the upright position, wherein said wall is connected to the pair of opposing walls at the opposing ends of the cooking surface.

20. The pellet grill of claim 11, wherein:
the pellet grill further comprises a grease drain configured to remove oil and grease from the housing;
the griddle further comprises:
a pair of opposing walls defining and extending upwardly from opposing ends of the cooking surface when the griddle is in the upright position, wherein each wall of the pair of opposing walls comprises a handle for lifting the griddle from the housing of the pellet grill; and
the cooking surface comprises an outflow, wherein said outflow is a hole through the cooking surface and the outflow is configured to drop excess oil and grease from food cooking on the cooking surface to the grease drain of the pellet grill.
